(19) United States
(12) Patent Application Publication
(10) Pub. No.: US 2018/0149242 A1
(43) Pub. Date: May 31, 2018

(54) Timing Error Correction System

(71) Applicant: GATES CORPORATION, Denver, CO (US)

(72) Inventors: William Fraser Lacy, Westland, MI (US); Benjamin R. Langhorst, Beverly Hills, MI (US)

(21) Appl. No.: 15/363,478

(22) Filed: Nov. 29, 2016

(51) Int. Cl. F16H 7/12; F16H 7/02

(52) U.S. Cl. CPC F16H 7/1281; F16H 2007/0806; F16H 7/023

(57) ABSTRACT

A timing error correction system comprising a three element linkage having at least one element pivotally mounted to a mounting surface, a timing belt engaged between a driver and a driven, a first element of the three element linkage in contact with a timing belt slack side, a second element of the three element linkage in contact with a timing belt tight side, and a spring imparting a load to the three element linkage.

### FIELD OF THE INVENTION

The invention relates to a timing error correction system, and more particularly, to a timing error correction system comprising a three element linkage, a first element of the three element linkage in contact with a timing belt slack side, a second element of the three element linkage in contact with a timing belt tight side, and a spring imparting a load to the three element linkage.

### BACKGROUND OF THE INVENTION

Synchronous belt drive systems are designed and optimized to minimize the relative angular displacement of connected rotating members, commonly called “timing error.” For example, in an automotive engine, the camshaft(s) are connected to the crankshaft with a synchronous belt that accomplishes two objectives: (1) transferring power from the crankshaft to the camshaft(s) causing the camshaft(s) to rotate, and (2) synchronizing the rotary position(s) of the camshafts to the rotary position of the crankshaft.

If a camshaft position deviates from its intended position relative to the crankshaft at any given moment, that angular position deviation is called “timing error.” Many factors contribute to timing error, including belt properties, sprocket design, tensioner and guide behavior, and drive operating conditions. While these factors can be adjusted to minimize timing error, there are certain cases where the minimum achievable timing error of the system remains too high.

Traditionally, timing error can be minimized by “stiffening” the system. This can be accomplished by a number of means including, but not limited to increasing belt stiffness, increasing tooth stiffness, increasing belt tension and tightening tensioner tolerances. However, these approaches have limits. For example, belt stiffness can be increased, but it eventually becomes economically or technically unfeasible to pack stiffer cords or more cords in the same belt cross-section. Tooth stiffness can be increased by changing the rubber tooth compound and the outer jacket material, but those materials can only be found in certain stiffness ranges and ultra-high-stiffness alternatives would have negative consequences for other aspects such as belt durability, meshing and noise. Increasing the belt tension is often highly effective, but subjecting the belt to extremely high tension decreases its durability.

Therefore, while these system properties can be modified to reduce timing error, there are limits to the extent they can be employed, and consequently, there is typically a minimum timing error level that can be feasibly achieved. However, program objectives may require timing error to be reduced to a level below the minimum timing error achievable through the traditional approaches listed above.

Representative of the art is U.S. Pat. No. 8,105,195 which discloses a tensioner for a power transmission system includes two tensioning arms operatively engaged with a strand of either the chain or the belt of the power transmission system. The upper end of each tensioning arm is connected to a one way rotational clutch which is pivotally mounted between the upper ends of the tensioning arms. The one way clutch rotates in one direction in response to changing chain loads to adjust the tension substantially equally on both strands at the same time. In order to prevent over-tensioning, a damping means is included in the one-way clutch. When a pre-determined overload threshold is reached, the amount of torque required to overcome the coefficient of friction of a spring in the damper allows the one way clutch to slip in the direction opposite from its normal rotational direction, thereby relieving the overload condition on the chain.

What is needed is a timing error correction system comprising a three element linkage, a first element of the three element linkage in contact with a timing belt slack side, a second element of the three element linkage in contact with a timing belt tight side, and a spring imparting a load to the three element linkage. The present invention meets this need.

### SUMMARY OF THE INVENTION

The primary aspect of the invention is to provide a timing error correction system comprising a timing error correction system comprising a three element linkage, a first element of the three element linkage in contact with a timing belt slack side, a second element of the three element linkage in contact with a timing belt tight side, and a spring imparting a load to the three element linkage.

Other aspects of the invention will be pointed out or made obvious by the following description of the invention and the accompanying drawings.

The invention comprises a timing error correction system comprising a three element linkage having at least one element pivotally mounted to a mounting surface, a timing belt engaged between a driver and a driven, a first element of the three element linkage in contact with a timing belt slack side, a second element of the three element linkage in contact with a timing belt tight side, and a spring imparting a load to the three element linkage.

### BRIEF DESCRIPTION OF THE DRAWINGS

The accompanying drawings, which are incorporated in and form a part of the specification, illustrate preferred embodiments of the present invention, and together with a description, serve to explain the principles of the invention.

FIG. 1 is a perspective view.

FIG. 2 is a schematic of the tensioner system.

FIG. 3 is a schematic of an engine with the tensioner system.

FIGS. 4a, 4b and 4c shows the conversion of linkage motion into timing counter-error.

FIG. 5 is a schematic of an alternate embodiment.

FIG. 6 is a graph of the time-history of angular displacement data.

FIG. 7 is a graph of timing error as a function of engine speed.

FIG. 8 is a graph of timing error as a function of engine speed.

### DETAILED DESCRIPTION OF THE PREFERRED EMBODIMENT

The inventive system creates timing error correction in a direction opposite to the timing error which a cam system would experience from a lack of system stiffness. From a materials and engineering standpoint, a synchronous belt timing system can be stiffened to reduce timing error, but only to a certain limit. This invention provides a way to induce timing error correction that counteracts the timing error caused by a lack of system stiffness. It enables system designers to reduce timing error without modifying the belt, employing exotic belt materials, or using system tuning devices that may reduce timing error at some frequencies while increasing timing error at other frequencies.

Further, the magnitude of timing error correction also scales with the magnitude of system timing error caused by deflection of the timing belt and hardware under engine loading conditions. As system timing error increases the timing error correction also increases which reduces net timing error. A further benefit is that the inventive system fits within a typical volume envelope of a timing belt-drive system so expansion of the timing belt-drive system to achieve lower timing error values is not required.

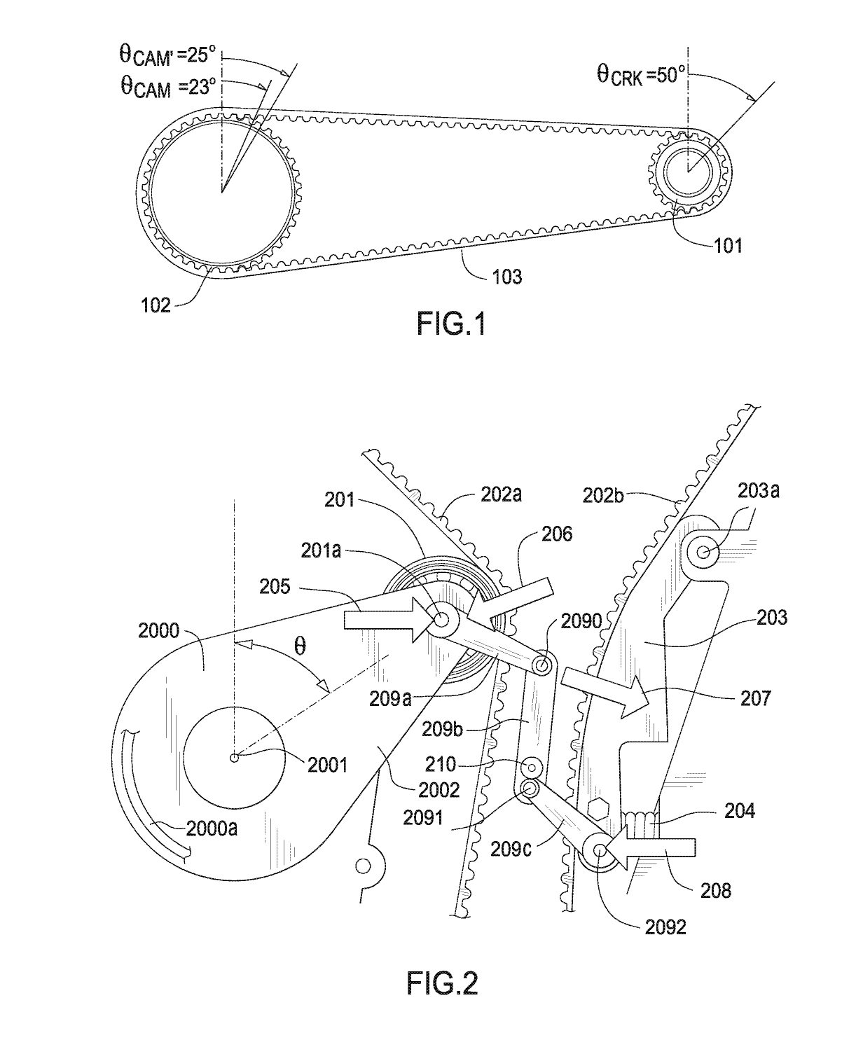

FIG. 1 is a prior art timing system. The system comprises a crankshaft 101 and camshaft 102. The crankshaft and camshaft are linked by an endless member such as a timing belt 103. The endless member may also comprise a chain.

Timing belt 103 is a toothed belt, also referred to as a synchronous belt. Synchronization is maintained between the crankshaft and camshaft by use of the toothed belt. Crankshaft rotates thereby driving camshaft 102 via the belt. Camshaft 102 actuates valves (not shown) in an internal combustion engine.

In order to actively correct timing error in this system a three element mechanical linkage system is described that connects the tight and slack sides of the timing belt. The linkage system features a central linkage member on a pivot point and two linkage members, one on each end of the central linkage member. One side of the linkage system is attached to an element engaged with the slack side of the timing belt, and the other side of the linkage system is attached to an element engaged with the tight side of the timing belt. The timing belt contacting elements may comprise a tensioner and a guide, or rotatably-mounted pulleys or rigid arc-shaped slide guide members.

A spring (or other external force mechanism) is connected to the linkage system such that the position of the linkage is influenced by three or more forces: the slack side belt tension, the tight side belt tension, and the external force mechanism.

Referring to FIG. 2, a three element linkage system connected between two belt contacting members is shown. The system comprises a spring-loaded slide-type guide 203. Guide 203 is movable about a pivot point 203a and may or may not contain a spring 204 to provide an external force 208 to the system.

The system further comprises a movable idler pulley 201. The center point 201a of the idler moves along an arcuate path. The mounting of the idler may or may not contain a spring to provide an external force 205 to the system. In this embodiment a torsion spring 2000a is contained in tensioner 2000 to which idler pulley 201 is rotatably journalled. Pivot arm 2002 pivots about axis 2001 thereby moving idler 201 through an arc during movement. Belt 202 is endless such as in a cam drive system, and tension in the belt exerts a force 206 on idler 201 and a force 207 on guide 203. Tensioner 2000 comprising pivot arm 2002 and torsion spring 2000a is known in the art. Tensioner 2000 is omitted form the following Figures for clarity.

The idler and guide are linked by a three element mechanical linkage 209 comprising linkage elements 209a, 209b and 209c. Linkage 209b is mounted to rotate around a pivot point 210. Pivot point 210 is attached to a mounting surface and does not move relative to the center points of the rotating drive members, e.g., crankshaft 500 and camshafts 550 and 551.

Linkage 209a is pivotally mounted to linkage 209b at pivot 2090. Linkage 209c is pivotally mounted to linkage 209b at pivot 2091. Idler 201 is journalled to linkage 209a at axis 201a. Guide 203 is pivotally connected to linkage 209c at pivot 2092.

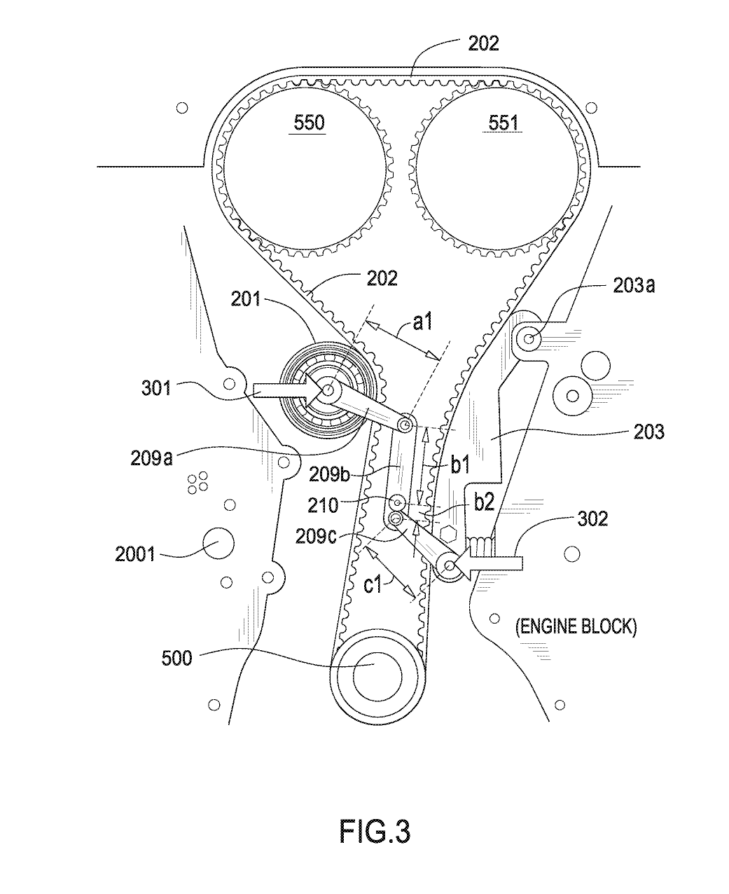

As slack side 202a timing belt tension decreases as a result of dynamic torques or speeds, idler 201 on the slack side 202a moves toward belt 202 to find a new equilibrium in light of the belt tensions and spring 204. This movement causes linkage system 209a, 209b and 209c to move correspondingly. As a result of this movement guide 203 moves toward belt 202b. This is shown by arrows 301 and 302 respectively in FIG. 3. Tensioner 2000 is omitted from FIG. 3 for clarity.

Considering system dynamics in concert with linkage system motion it becomes clear how this design can induce a timing error correction. For example, the system can be applied to an internal combustion engine where the crankshaft 500 is driving one camshaft 550. If during operation the crankshaft momentarily surges ahead of the camshaft, the system would exhibit timing error with the camshaft angular displacement being temporarily negative (“lagging” or “behind”) with respect to the crankshaft. This condition, where camshaft angular position lags behind the crankshaft angular position will cause a small length of belt to be pulled from the tight side 202b into the slack side 202a causing tight side tension to increase and slack side tension to decrease.

As slack side tension decreases, the slack side idler 201 moves into the belt under the influence of tight side loads and the spring 204 operating on the linkage 209 through guide 203. This motion causes the linkage system 209 to move and pull guide 203 into the belt 202b. As guide 203 is forced into the belt it causes belt tension to rise further on the tight side 202b. This tension increase is transferred to both the crankshaft and camshaft sprockets as torques. The torque increase on the camshaft sprocket is in the direction of belt motion, causing the camshaft to momentarily accelerate and the angular displacement of the camshaft relative to the crankshaft to become less negative. The torque increase on the crankshaft sprocket is opposite the direction of belt motion, causing the crankshaft to decelerate and angular displacement of the camshaft relative to the crankshaft to become further less negative.

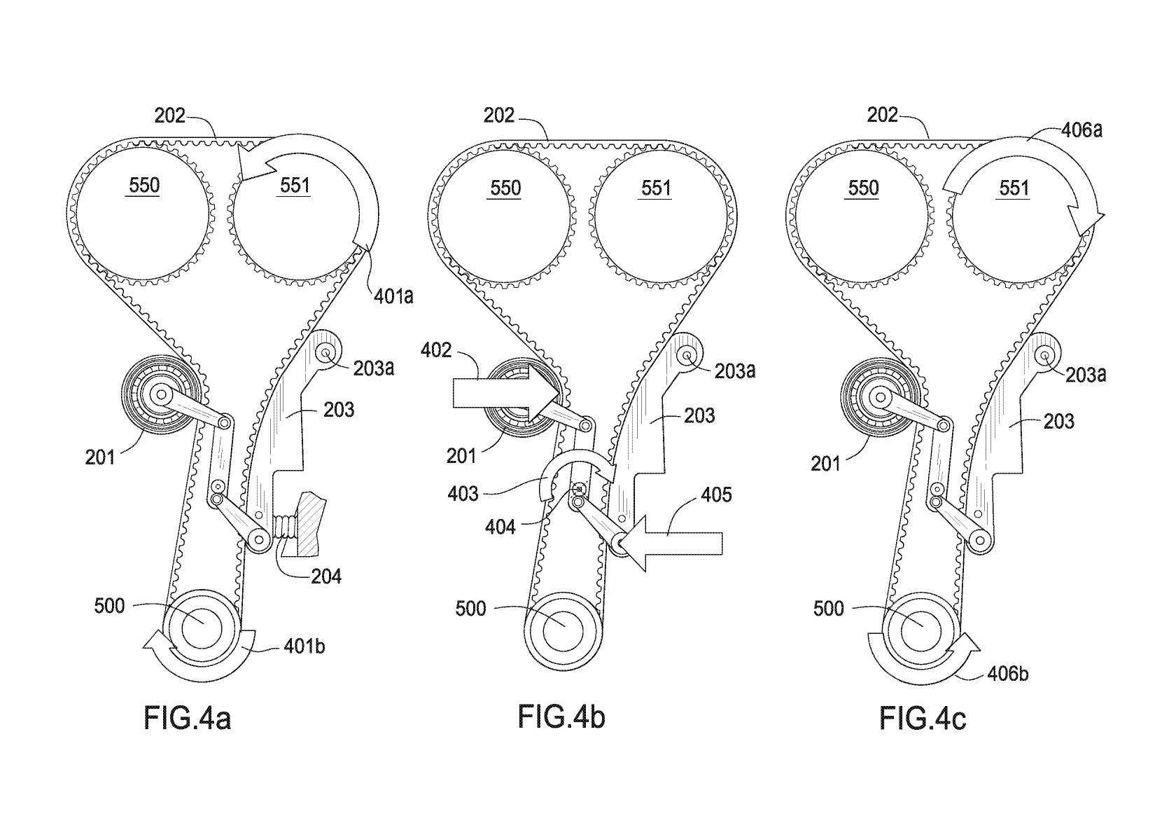

FIGS. 4a, 4b and 4c shows the conversion of linkage motion into timing error correction. Tensioner 2000 is omitted from FIG. 4 for clarity. By mechanically translating a slack side tension decrease FIG. 4a into a tight side tension increase FIG. 4b via forces 402 and 405 and torque 403, the camshaft and crankshaft are subjected to torques 406a and 406b in FIG. 4c that create angular displacement in the opposite direction of the angular displacement 406 that caused the slack side tension decrease (torques 401a and 401b) in shown in FIG. 4a. Tensioner 2000 is omitted for clarity.

Example system results:

### Setup A:

Tensioner spring: kA=0.36 N*m/deg, tensioner 2000 is unloaded when tensioner arm 2002 is θ=80 deg clockwise from vertical.

No center spring. In this embodiment three guide springs 204 are provided.

Center Link 209b: b1=50 mm, b2=10 mm
Link to Tensioner 209a: a1=54 mm
Link to Guide 209c: c1=45 mm
Dynamic Summary 1A:

Slack Side tension changes from 253N to 217N
Arm 2002 Angle θ moves into belt by 35.6165−35.0510=0.5655 deg

Tight Side Tension changes from 249N to 686N
Guide Angle moves into belt by 19.6372−19.5576=0.0796 deg

When 0.5 mm of belt is removed from tight side 202b, system reacts and elongates belt path by 0.06557 mm causing further stretch or sprocket rotation to feed belt into path.

Dynamic Summary 2A:

Slack Side Tension changes from 236N to 203N
Arm Angle θ moves into belt by 35.5937−35.0228=0.5709 deg

Tight Side Tension changes from 247N to 684N
Guide Angle moves into belt by 19.6340−19.5536=0.0804 deg

When 0.5 mm of belt is removed from tight side 202b, system reacts and elongates belt path by 0.0660 mm causing further stretch or sprocket rotation to feed belt into path.

Setup B:

Tensioner spring: kA=0.36 N*m/deg, tensioner 2000 is unloaded when tensioner arm 2002 is 80 deg CW from vertical.

No center spring.

Three guide springs as originally designed
Center Link 209b: b1=30 mm, b2=20 mm
Link to Tensioner 209a: a1=72 mm
Link to Guide 209c: c1=45 mm

Dynamic Summary 1B:

Slack Side Tension changes from 257N to 88N
Arm Angle θ moves into belt by 35.4169−35.0649=0.3520 deg

Tight Side Tension changes from 272N to 776N
Guide Angle moves into belt by 19.7749−19.5819=0.1930 deg

When 0.5 mm of belt is removed from tight side 202b, system reacts and elongates belt path by 0.1416 mm causing further stretch or sprocket rotation to feed belt into path.

Dynamic Summary 2B:

Slack Side Tension changes from 201N to 61N
Arm Angle θ moves into belt by 35.3815−34.9822=0.3993 deg

Tight Side Tension changes from 244N to 762N
Guide Angle moves into belt by 19.7032−19.4837=0.2195 deg

When 0.5 mm of belt is removed from tight side 202b, system reacts and elongates belt path by 0.1557 mm causing further stretch or sprocket rotation to feed belt into path.

In an alternative embodiment, the tensioner system comprises a single link between the idler and the guide. Idler 201 on tensioner 2000 is journalled to one end of linkage member 501. The other end of linkage member 501 is pivotally joined to guide 203. Linkage member 501 is not otherwise mounted to a mounting surface.

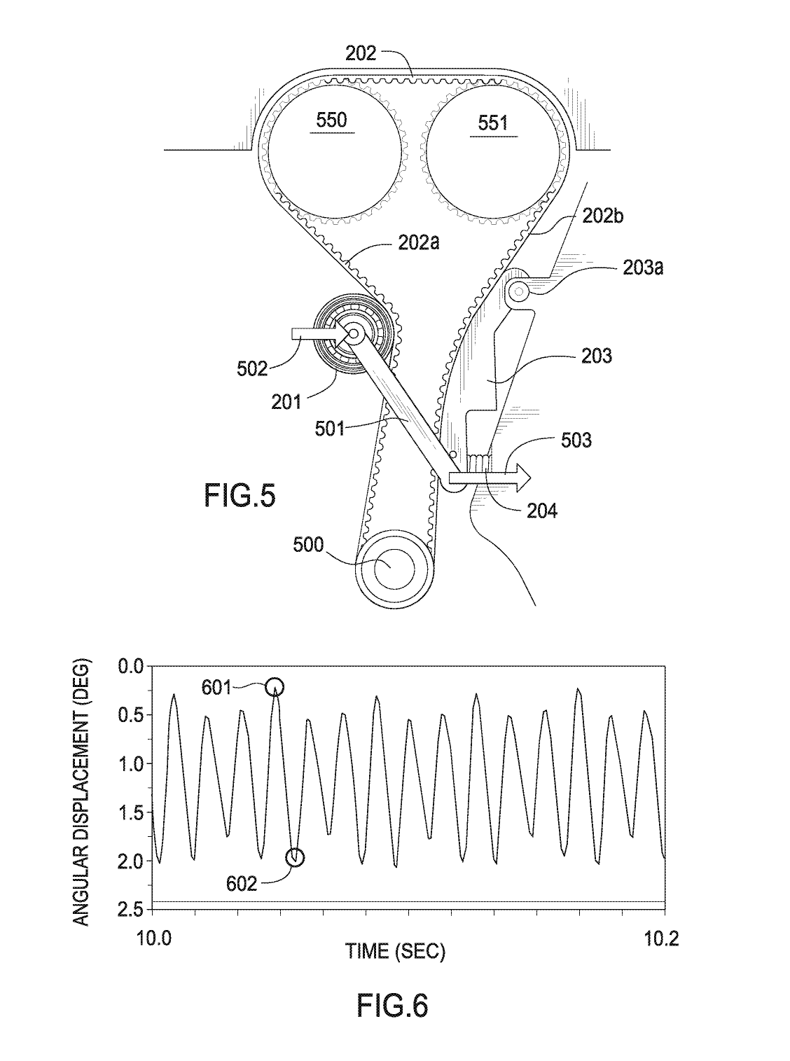

The single link embodiment as shown in FIG. 5 results in system behavior that is different than the pivoting multi-link system 209 described in FIG. 3. In the event that the crankshaft 500 runs ahead of the camshafts 550 and 551 and angular displacement occurs, idler 201 will move toward belt 202 through operation of tensioner 2000. The linkage connection will cause guide 203 to move away from belt 202, thus decreasing tension in the belt tight side span 202b. In a static situation, this behavior would cause the timing error to be exacerbated, rather than improved. However, in a dynamic event the system can be designed to resonate at specific speeds and vibrate out of phase from angular displacement cycles to cancel out timing error. Tensioner 2000 is omitted from FIG. 5 for clarity.

In order to properly design a linkage system to exhibit the “timing counter-error” behavior described above, a system of simultaneous equations must be solved. Further, because angular displacement is a dynamic quantity that oscillates between different maxima and whose maxima depend on independently dynamic engine conditions, the system of equations must be solved in more than one state.

The states for which the equations are solved depend on engine load conditions and should be selected to represent the engine conditions where maximum and minimum angular displacements occur. For example, FIG. 6 shows a time-history of angular displacement data, with maximum points of angular displacement indicated, 601, 602. By designing the tensioner linkage system to operate between the conditions at these two points (601, 602), the system utilizes these loading states to create the appropriate amount of timing counter-error.

In order to properly design the system to create timing counter-error behavior, at least three numerical equations must be quantified:
Moment that the slack side of the belt exerts on the idler 201 as a function of the position of the idler.
Moment that the tight side of the belt exerts on the guide 203 as a function of the position of the guide.
Moment that any external springs exert on either the idler, the guide, or the linkages between those components as a function of the position of the hardware that it acts upon (there may be multiple applicable equations in this category).

These three equations must be derived for each maximum loading state. The equations can be measured on the physical system, or calculated from first principles using geometric calculations, belt properties, and assuming that crankshaft and camshaft rotary positions are held constant (i.e. the numbers of belt teeth between each engaged sprocket are held constant). Analyzing one loading state at a time, the three equations are then incorporated into static force-balance equations:
1. Forces and moments on the idler 201 considering belt contact forces, linkage forces, and any applicable external spring member forces.
2. Forces and moments on the guide 203 considering belt contact forces, linkage forces, and any applicable external spring member forces.
3. Forces and moments on the linkage system 209 considering forces from the idler 201 and guide 203 and any applicable external spring member forces.
4. Belt tension on span 202a and span 202b.

When developing the belt tension balance (equation 4.) it may not be correct to set the belt tensions on the two belt spans (202a, 202b) equal to one another. Instead, it may be appropriate to design the system with a specific tension ratio (e.g. 4:5) between the tension on the slack side 202a and the tension on the tight side 202b.

This system of equations can be solved to find a set of geometric positions where the four force balance equations (1-4) above are satisfied for a single maximum loading condition. By repeating the procedure considering a second maximum loading condition a new set of geometric positions can be calculated where the force balance equations are satisfied for the second maximum loading condition.

Comparing the two states, one should confirm the system conditions in the two states are appropriate. For example, if the two states are selected to be (a) an instance where crankshaft and camshaft are perfectly synchronized, and (b) an instance where the camshaft lags behind the crankshaft, it is important to ensure that the corresponding calculated states indicate that when moving from state (a) to state (b), the slack-side belt 202a tension decreases, the tight-side belt 202b tension increases, and the linkage angle changes to move both the idler and guide further into their respective belt paths. It is also important to ensure that the tensions and angles in both states are reasonable engineering values for the system to achieve.

The analytical approach described above predicts the following changes between the states:

| | State 1 | State 2 |
|---|---|---|
| Angular Displacement | 0° | 1° |
| Left side belt 202a | 257N | 88N |
| tension | | |
| Right side belt 202b | 272N | 776N |
| tension | | |
| Linkage 209b | 19.8° | 21.3° |
| orientation | | |
| Right side belt 202a | n/a | 0.14 mm |
| path elongation | | |

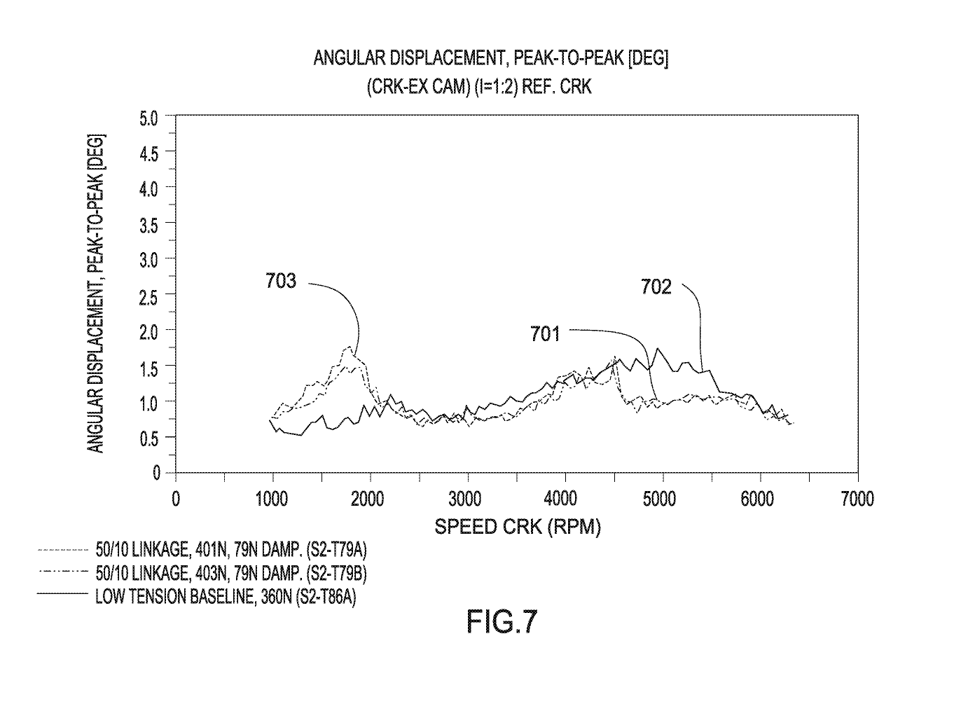

The action of the linkage system 209 causes the belt tight side path 202b elongation, which creates timing “counter-error.” This embodiment was found to reduce timing error that occurred at high speeds by approximately 10%. Timing error as a function of engine speed is shown in FIG. 7. Testing showed that a low-speed timing error peak 703 occurred, but it is believed that this peak was caused by the resonant vibration of the tensioner arm 2002, which can be mitigated by an improved damping design. The low-speed (<3000 rpm) peak can likely be eliminated by adding or altering tensioner damping. Thus, the focus in this comparison is on the high-speed (>3000 rpm) peak, where the described linkage system significantly reduces timing error.

In an alternative embodiment, spring elements could be applied to any part of the linkage system or the elements that move along with the linkage system, e.g. belt contacting elements, tensioner arm, guide arm, and so on. The present embodiment contains a spring 204 that applies a moment to the guide, however, spring 204 can be located elsewhere, or additional springs could be incorporated.

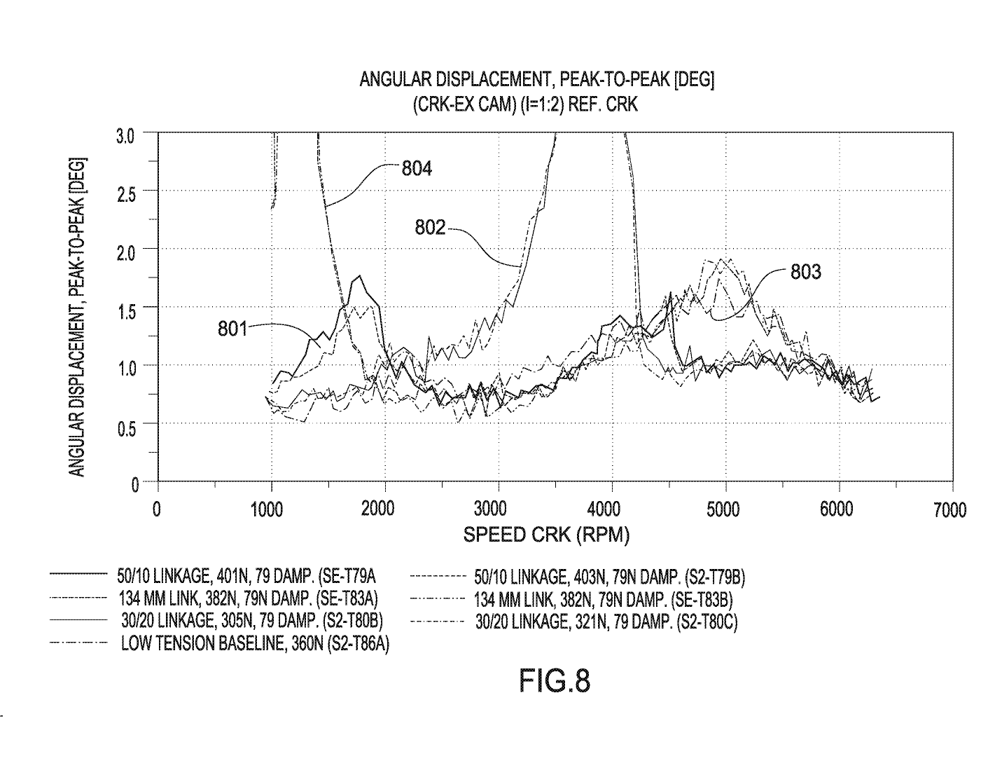

In an alternative embodiment, the linkage member can be replaced with a single linkage member as described in FIG. 5. For example, a single linkage member that is 134 mm long. This configuration demonstrates regions of low timing error as well as regions of high timing error 802, see FIG. 8. The analytical models used to design the system predicted that the 134 mm single linkage member is somewhat less effective at reducing timing error than the linkage system 209.

FIG. 8 is a graph of timing error as a function of engine speed. Alternative arrangements can be employed to achieve different timing error reduction trends. For example, a 209b b1=50 mm/b2=10 mm linkage (801) and b1=30 mm/b2=20 mm linkage (802) successfully reduce high speed timing error relative to a standard tensioner baseline (803). The 50/10 linkage has a low-speed resonance peak that can be mitigated with tensioner damping. The 30/20 linkage had a medium-speed resonance peak that might be inherent due to the more extreme tension changes that this design creates.

In an alternative embodiment, an electro-mechanical actuation mechanism could be utilized to apply an external force to any part of the system to create timing error correction of a specific magnitude and frequency such as to counteract the system timing error.

In yet another alternative embodiment, a switchable system could be designed that enables the linkage geometry to change by known mechanical or electro-mechanical means such as solenoids or stepper motors. The switchable system can be designed to change between different geometries to select the geometry that will deliver the lowest timing error for the engine operating conditions at that time.

A timing error correction system comprising, a three element linkage having an pivot element pivotally mounted to a mounting surface, an endless member engaged between a driver and a driven, a first element of the three element linkage comprising an idler in contact with an endless member slack side, a second element of the three element linkage comprising a guide in contact with an endless member tight side, a first spring imparting a load to the three element linkage through the idler, and the pivot element disposed between the first element and the second element

Although a form of the invention has been described herein, it will be obvious to those skilled in the art that variations may be made in the construction and relation of parts and method without departing from the spirit and scope of the invention described herein.

1. A timing error correction system comprising:
a three element linkage having an pivot element pivotally mounted to a mounting surface;
a timing belt engaged between a driver and a driven;
a first element of the three element linkage in contact with a timing belt slack side, the first element of the three element linkage engages an idler in contact with the timing belt slack side;
a second element of the three element linkage in contact with a timing belt tight side, the second element of the three element linkage engages a guide in contact with the timing belt tight side; and
a first spring imparting a load to the three element linkage.

2. (canceled)

3. The timing error correction system as in claim 2 further comprising a second spring urging the guide toward the timing belt.

4. The timing error correction system as in claim 3, wherein the pivot element is disposed between the first element and the second element.

5. (canceled)

6. A timing error correction system comprising:
a three element linkage having an pivot element pivotally mounted to a mounting surface;
an endless member engaged between a driver and a driven;
a first element of the three element linkage comprising an idler in contact with an endless member slack side;
a second element of the three element linkage comprising guide in contact with an endless member tight side;
a first spring imparting a load to the three element linkage through the idler; and
the pivot element disposed between the first element and the second element.

7. The timing error correction system as in claim 6 further comprising a second spring urging the guide into the endless member.

8. The timing error correction system as in claim 6, wherein the driver comprises a crankshaft and the driven comprises a camshaft.

9. The timing error correction system as in claim 6, wherein the endless member comprises a toothed belt.

10. A timing error correction system comprising:
a driver and a driven rotationally connected with an endless member;
a three element linkage engaged between an endless member tight side and an endless member slack side, the three element linkage engages the endless member slack side through an idler, and the three element linkage engages the endless member tight side through a guide;
a spring imparting a load to the three element linkage; and
the three element linkage pivotally mounted to a mounting surface.

11. (canceled)

12. The timing error correction system as in claim 10 further comprising a spring to urge a guide into the endless member.

13. The timing error correction system as in claim 10 wherein the endless member comprises a timing belt.

14. The timing error correction system as in claim 12, wherein the spring imparts the load to the idler.

15. The timing error correction system in claim 6, further comprising the idler journalled to a pivot arm, said pivot arm is pivotally mounted to a mounting surface.

16. The timing error correction system as in claim 15, wherein the pivot arm movement is dampened.
